(19) United States
(12) Patent Application Publication
(10) Pub. No.: US 2017/0246659 A1
(43) Pub. Date: Aug. 31, 2017

(54) SYSTEM AND METHOD FOR PROTECTION AGAINST ULTRAVIOLET RADIATION

(71) Applicant: John C. BECKER, IV, Palmer, MA (US)

(72) Inventor: John C. BECKER, IV, Monson, MA (US)

(73) Assignee: John C. Becker, IV

(21) Appl. No.: 15/444,740

(22) Filed: Feb. 28, 2017

Related U.S. Application Data
(60) Provisional application No. 62/301,188, filed on Feb. 29, 2016.

(51) Int. Cl. B05D 5/06; B05D 3/00; E04D 1/22; B05D 7/02; B05D 7/24; B05D 1/26; B05D 3/10

(52) U.S. Cl. CPC B05D 5/06; B05D 1/265; B05D 3/007; B05D 3/101; B05D 7/02; B05D 7/24; E04D 1/22

(57) ABSTRACT

An UV (ultraviolet), IR (infrared) and NIR (near infrared) protection system and method for surfaces or substrates that experience degradation from solar radiation, UV/IR/NIR exposure. The method for protecting a substrate from UV degradation includes treating a surface of the substrate to allow a UV blocking agent to adhere to the surface of the substrate, applying the UV blocking agent to the surface of the substrate, and allowing the surface of the substrate to harden, thereby adhering the UV blocking agent to the surface of the substrate. The UV/IR/NIR protection system is tunable so that specific ranges of the UV spectrum may be blocked to reduce or eliminate UV degradation. The UV protection system may be in the form of a dispersion, suspension, emulsion, or in other liquid application form; in a solid particle form; or a pre-mold/precast transfer medium when applied to or it becomes the given substrate.

### BACKGROUND

Field of Disclosure

The present disclosure is directed to the protection of materials from solar and ultraviolet (UV) degradation. This disclosure has particular applicability to protecting coatings, composites, building materials, and all substrates exposed to sunlight and ultraviolet rays that experience degradation therefrom.

Description of Related Art

Throughout history mankind has tried to deal with the negative effects of ultraviolet solar radiation exposure. More recently, as scientists developed synthetic materials, UV solar radiation has been increasingly identified as a primary enemy of long-term service life. Ultraviolet solar radiation is constant and ubiquitous and man-made materials and structures all suffer from degradation caused by exposure to UV solar radiation.

The UV solar radiation affects materials by degrading them through decompositional and intermolecular cohesive bond degradation forces exposed to a polymeric or non-polymeric surface and then into the polymeric or non-polymeric molecular matrix. This causes intermolecular reactions that degrade (and create free radicals) the intramolecular cross-link density, intermolecular cross-linking and inter molecular integrity that results in the reduction, loss of, and eventual failure of physical properties.

One way to reduce UV exposure is by covering a substrate or surface to be protected with a physical material. Hence, building enclosures have roofs even though they may be intended for temporary shelter or periodic use. Another example of physically covering with a physical material to reduce the effects of UV exposure is by protecting the exposed substrate or surface with a coating or paint designed to block the UV exposure and subsequent degradation to that substrate or surface.

This discovery allows for not only a UV Protection System (UVPS) to become part of a paint or coating to protect a given substrate but also for that UV Protection System to become an integral component of and within the substrate to be protected itself as in cast, composite, or extruded materials. When the word “paint” or “coating” is used in this application, it shall be meant to include all substrate materials into which the UV Protection System can be incorporated.

As coating science and material development has progressed, the level of UV protection has advanced through the development of UV absorbers, UV blockers, free radical scavengers, and other UV hindering materials that are incorporated into a paint, coating, or substrate based materials and become an integral part of those coatings, substrate based material or paint films. Therefore, they are dispersed throughout the entirety of the thickness of the coating or paint film. The primary protection from UV exposure is required at the exposed surface, which is the interface of the paint or coating and the ambient or exposure environment. The counter to this is that as the paint or coating degrades from UV exposure, there will continue to be UV absorbers, blockers or other UV hindering materials at the new level of the degraded thickness of that paint or coating.

The effectiveness and functionality of a great majority of UV protection techniques such as by UV absorbers, UV blockers, and other UV hindering materials in the marketplace today are limited in their service life in that they too, degrade over time and provide less protection.

The challenge however has been to incorporate UV blockers or UV absorbers/hinderers that that can block or affect UV exposure in the specific wavelength ranges to which the given coating of paint or substrate is most sensitive or reactive to degradation by UV exposure. Therefore, these new materials end up blocking UV wavelengths from which little to no degradation would otherwise occur and simultaneously do not provide maximum efficacy against the UV wavelengths from which the substrate, coating, or composite, will experience most degradation, which is at or near the surface of the substrate.

Inasmuch as UV degradation has proven to be an enemy of more modern synthetic and man-made materials, the degradation and performance reduction effects of infrared solar radiation (IR) and near infrared (NIR) should not be overlooked. The process acid method described herein for UV protection may also be used and practiced to block and reduce the penetration of IR solar radiation into and through materials that can then cause damage through a build up of or exposure to the heat generated by the longer wavelengths of IR radiation. When terms such as solar radiation, UV, ultraviolet, UV radiation or UV Protection System are used in this document, it may be read to include IR and NIR as to practice of the art.

### SUMMARY

In order to overcome the problems discussed above, the present disclosure is directed to a UV protection system that comprises the ability to selectively tune or tailor the ultraviolet wavelength ranges that will be blocked by the UV protection system.

One embodiment of the present disclosure includes

The present disclosure is also directed toward methods for forming the UV protection system on a substrate, coating, or composite comprising the step of preparing the substrate for adhesion, applying the UV protection system, and for providing long service wear life for the installed system.

In another embodiment of the present disclosure, the UV protection system is applied or distributed evenly across the substrate, coating, or composite, which is then exposed to an energy source that will soften the surface of the substrate to enable the UV protection system, as a mixture of particles, to become bonded to the substrate.

In another embodiment of the present disclosure, the UV protection system comprises a resin. The UV protection system may be dispersed, or suspended within that resin such that the system may be applied through conventional means of application of the resin.

In another embodiment of the present disclosure, the UV protection system comprises particles that have been chemically altered to enable the UV protection system particle to form a chemical bond with a particular resin to be used in the system. An example of this is the use of organosilanes, organosilicon materials or similar coupling agents that provide a bond to inorganic materials through a reaction that produces stable covalent bonds with the particle(s) through siloxane or similar silicone derivative reaction and also provide an organic functionality (OH, COOH, NH, CH₃, etc) to enable a bond to form between dissimilar materials such as the organic polymer/resin and inorganic particles or non-polymeric materials of the UV Protection System.

Another embodiment of the present disclosure includes a method for protecting a substrate from UV degradation comprising treating a surface of the substrate to allow a UV blocking agent to adhere to the surface of the substrate, applying the UV blocking agent to the surface of the substrate, and allowing the surface of the substrate to harden, thereby adhering the UV blocking agent to the surface of the substrate.

In this method, treating the surface of the substrate may include exposing the surface of the substrate to a solvent capable of softening the surface of the substrate to a sufficient degree to allow for the UV blocking agent to adhere to the surface.

In another embodiment, treating the surface of the substrate may include heating the surface of the substrate to soften the surface of the substrate to a sufficient degree to allow for the UV blocking agent to adhere to the surface in such a degree as to limit the exposure of UV radiation to the surface.

In another embodiment, treating the surface of the substrate may include applying a sufficient amount of an adhesive to the surface of the substrate to allow for the UV blocking agent to adhere to the surface in such a degree as to limit the exposure of UV radiation to the surface.

Applying the UV blocking agent to the surface of the substrate may include mixing the UV blocking agent with a resin to form a resin and UV blocking agent mixture and applying the mixture to the surface of the substrate.

The UV blocking agent may be at least one selected from the group consisting of titanium oxide, iron oxide, tungsten oxide, tungstate, graphene oxide, cerium oxide, nanoceria, aluminum oxide, zinc oxide, and aluminum hydroxide.

The concentration of UV blocking agent in the UV blocking agent and resin mixture may be from 0.1 wt % to 50 wt % of the total weight of the mixture. In other embodiments, the concentration of UV blocking agent in the UV blocking agent and resin mixture is from 0.1 wt % to 10 wt % of the total weight of the mixture.

The mixture may be applied to the substrate by spraying, casting, extruding, or pouring the mixture onto the substrate.

The UV blocking agent may have a particle size capable of allowing a predetermined UV wavelength to pass through without being blocked.

In other embodiments, the substrate may be comprised of EPDM, polyurethane, TPO, acrylate, or vinyl. The solvent may be at least one selected from the group consisting of amyl chloride, aromatic hydrocarbons, ketones, methylene chloride, lacquer thinners, mineral spirits, perchlorethylene, acetone, methylethyl ketone, methyl isobutyl ketone, isopropyl acetate, propionic acid, pyridine, and n-Butyl acetate.

The UV blocking agent is capable of blocking at least 90%, at least 95%, or at least 97% of UV radiation from being exposed to the substrate.

In other embodiments, a UV protection system comprises a substrate having a surface; and a UV blocking agent at the surface of the substrate. The UV protection system may be formed as described above. The system may be used with roofing materials, filter laminates, coatings or objects that are exposed to sunlight, and may be physically placed between or above the source of the UV and an object or surface to be protected.

In other embodiments, a pre-formed coating comprising the UV protection system may be laminated onto another receiving surface.

Additional advantages and other features of the present disclosure will be set forth in part in the description that follows and in part will become apparent to those having ordinary skill in the art upon examination of the following disclosure. The advantages of the disclosure may be realized and obtained as particularly pointed out in the appended claims.

As will be realized, the present disclosure is capable of other and different embodiments, and its several details are capable of modifications in various obvious respects, all without departing from the disclosure. Accordingly the figures and description are to be regarded as illustrative in nature, and not as restrictive.

Further, the present disclosure may be utilized in a wide variety of applications and exposures whereby protection of a given substrate or material from specific ranges of solar radiation is desired. Additionally, the present disclosure may be utilized in applications and exposures whereby protection of the space below the substrate or material is desired from exposure to specific ranges of solar radiation. An example would be solar panel covers and laminates whereby the unwanted solar radiation heats the interior of the solar panel causing loss of efficiency in solar radiation to energy conversion and increased thermal degradation or cell phone covers where the exposure to solar radiation can cause failure of the devices to operate correctly.

### BRIEF DESCRIPTION OF THE DRAWINGS

FIG. 1 is a UVPS dispersed into a cross-linking resin with or without heat treatment according to one embodiment of the present disclosure.

FIG. 2 is a UVPS dispersed into a cross-linking resin with solvent treatment and with or without heat treatment according to another embodiment of the present disclosure.

FIG. 3 is a UVPS dispersed into a non cross-linking resin with solvent treatment and with or without heat treatment according to another embodiment of the present disclosure.

FIG. 4 is a UVPS dispersed into a non cross-linking resin with solvent treatment and with or without heat treatment according to another embodiment of the present disclosure.

FIG. 5 is a UVPS spread out onto a surface as a powder particulate according to another embodiment of the present disclosure.

FIG. 6 is a UVPS dispersed into a cross-linking or non cross-linking resin with or without solvent treatment according to another embodiment of the present disclosure.

FIG. 7 is a UVPS spread out onto a surface as a powder particulate and imbedded with mechanical force according to another embodiment of the present disclosure.

### DETAILED DESCRIPTION

The UV protection system(s) and methods of manufacturing the system(s) of the present disclosure employ UV and/or IR/NIR blocking particles that may be dispersed into a liquid resin or coating, or may be dispersed in particle form free of a liquid coating or may be dispersed in another type of resin that is not typically used as a coating resin. These particles are derived through mechanical processing to achieve the specific particle size such that the ultraviolet radiation is mechanically or physically blocked by designing the particle size to disrupt the ultraviolet radiation wavelength in the targeted UV exposure blocking range.

The achievement of the nanoparticles size necessary to mechanically or physically block ultraviolet radiation wavelengths may be achieved through traditional ball mill, horizontal ball mill, or other grinding techniques or through the new higher efficiency three-dimensional ball mills that have been introduced into the marketplace by Fumiyoshi Nagao of Nagao System.

Typically, when UV protection of a given substrate, coating, and/or composite is desired, a protective coating system is designed having a resin that will be aliphatic in nature. Aliphatic resins are known to be UV stable in that they take longer to break down under exposure to UV radiation. On the contrary, aromatic resin systems are known to discolor and fail relatively quickly compared to aliphatic systems. One challenge is that the increased cost of the aliphatic resin systems may drive certain projects to become uneconomical. Therefore, the present disclosure may allow the utilization of aromatic resin-based systems that are then protected by application of the UV protection system disclosed in this application. It is well known that ultraviolet rays will normally not penetrate further than three mils (0.003 inches) and therefore when an aromatic system begins to degrade, it is degrading at a rate of three mil or less per cycle. The degradation rate may vary slightly according to the chemistry of the coating or exposed substrate.

Other resins capable of being utilized as resin materials for use in the coating in the present disclosure include but are not limited to polyurethane, acrylates, MMA, acrylics, poly vinylidiene fluoride (PVDF), (a/k/a as Kynar®), TPO, epoxy, acrylic, polyvinyl alcohol, polyvinyl acetate, polyvinyl chloride, polyester, polyimide, polyether ether ketone, and polycarbonate.

A method for designing and forming a UVPS according to one embodiment of the present disclosure is as follows:

First, the specific substrate surface condition must be identified along with any coatings, contaminations, or other treatments that may impact proper adhesion and/or cohesion of the UV protection system so as to determine the appropriate cleaning and/or preparation required of the substrate to achieve optimum bond strength.

Second, the nature of the specific substrate must be identified so as to determine the appropriate strategy to provide mechanical and/or chemical bonding of the UV protection system to the given substrate.

Third, the most appropriate method of gaining mechanical and/or chemical bonding of the UV protection system to the given substrate must be identified. For example, if the second step above determined that a solvent treatment is the chosen method to soften the surface of the substrate or the surface to he protected so that the UV protection system may either have mechanical bonding through the particle penetration into a softer medium or become an integral part of the near surface of the substrate; then the most appropriate solvent must be selected considering factors such as flash temperature, environmental impact, the thoroughness of evaporation and/or volatilization, any required heating required for the solvent to fully volatilize, and the exposure time and quantity of solvent necessary to soften the substrate without destroying the cross-linked density of the surrounding polymeric or non-polymeric matrix along with user or customer requirements. This involves identifying solvents for which the substrate, paint, and/or coating is known to have poor resistance to and then qualifying each of those solvents according to the criteria listed above. Additional factors such as cost, availability of raw material, and other factors that anyone skilled in the art are familiar with may also be taken into account. The flash temperature is the volatilization temperature at which no residual solvent remains after evaporation.

Fourth, the environment in which the application will be made. Environmental regulations and worker safety requirements must be taken into account when designing the most appropriate method of gaining mechanical and/or chemical bonding of the UV protection system to the given substrate.

Fifth, if a solvent treatment resulting in a softening of the substrate surface is selected as the path to be followed, then in order to achieve a chemical bond instead of a mechanical bond, a compatible resin system, such as one that shares its chemical functionality with the substrate's, into which the solvent may be incorporated should be identified. Further, the solvent compatible resin system will also need to be compatible with the given substrate such that the solvent compatible resin system will bond into the molecular matrix of that given substrate. Best results are accomplished by mixing the appropriate solvent into the resin that has the same functionality; either hydroxyl, carboxyl, silicone, vinyl or other as the substrate matrix possesses. In addition, the amount of solvent must be determined to avoid over-use of the solvent, which may lead to unwanted excessive softening and/or destruction of the integral chemical matrix and therefore the physical properties of the substrate.

Sixth, as the solvent treatment that is included in the mixture of the solvent, resin, and UV protection system is applied to the substrate, the solvent will soften the substrate allowing the solvent and resin mixture to penetrate into the substrate. Then, as the solvent evaporates and/or volatilizes through the polymer film being formed, the UV protection system will be dispersed throughout the remaining resin polymer film as it cross-links. Because the resulting coating film is now serving as a topcoat and therefore has the greatest UV exposure, it is highly recommended that an aliphatic resin be used for that compatible resin system.

Optionally, another embodiment is a method to coat very thin layers of UV-protection materials on peelable sheets that could be removed periodically. Using this embodiment, the discovery foresees the temporary application of peelable sheets whereby UV-C wavelengths are allowed to pass through the sheet for microbial disinfection but other UV and/or IR wavelengths are blocked to protect the surface from degradation associated with the blocked wavelengths. Using this embodiment, the discovery foresees the temporary application of peelable sheets or lotions whereby UV-C wavelengths are allowed to pass through the sheet or film for microbial disinfection of skin and other biological surfaces but other UV and/or IR wavelengths are blocked to protect the surface from degradation and damage associated with the blocked wavelengths.

Another approach to obtain adhesion into a given substrate is to use heat to soften the substrate. Thermoset substrates may be softened with heat but should not be melted because they will not reconstitute into the original polymeric matrix. Thermoplastic substrates, however, may be heated and the surface may be melted to enable the UV protection system to obtain adhesion from distribution onto and if needed mechanical embedding into the substrate. Commercially available heating equipment may be utilized to achieve these results.

An alternative approach to obtain adhesion into a given substrate with the use of heat to soften the substrate surface is to incorporate NIR (near infrared) dyes that exhibit a significant thermal response when exposed to IR radiation in the 980-1100 nm range. These dyes, when incorporated into a compatible resin to the substrate onto which the UV protective system is to be applied and activated with the appropriate IR curing equipment will produce sufficient energy to melt many substrates enabling appropriate wetting of the UV protection system particles if the system is not in a liquid carrier, or appropriate penetration if the UV protection system particles are in an appropriate carrier. Care should be taken to ensure that no filler, colorant, functional filler, or other particulate matter is in the carrier resin that would block the IR wavelengths necessary to react with the IR dyes.

In another embodiment of the present disclosure, the protective layer is adhered to the substrate by use of an adhesive. Any suitable adhesive that can withstand exposure to outdoor elements may be used.

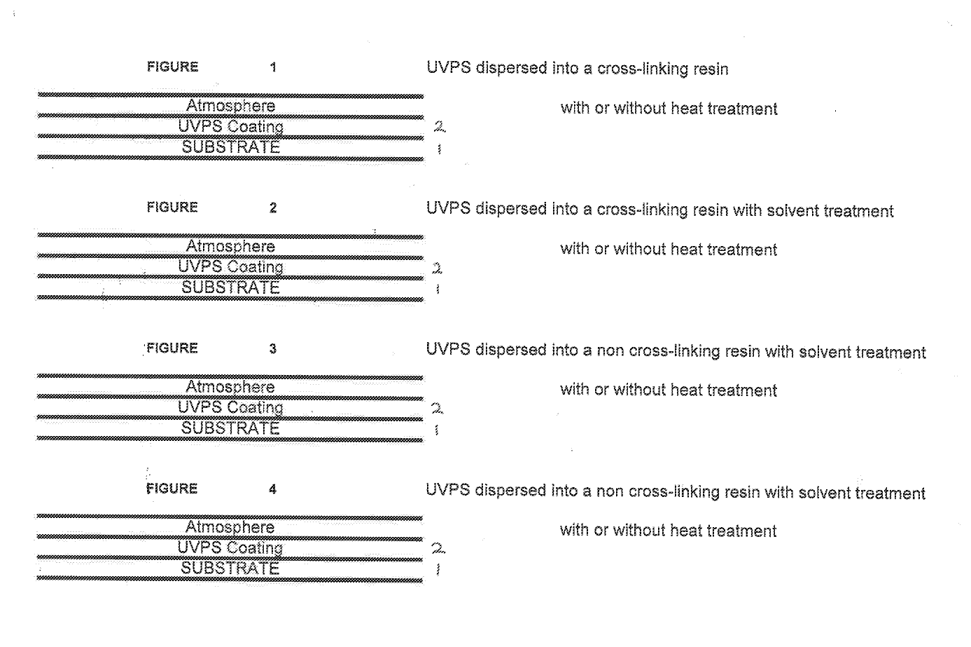

FIGS. 1-7 show various representations of the above-mentioned embodiments. For example, FIG. 1 is a UVPS coating 2 dispersed into a cross-linking resin that is formed on a substrate 1. The coating may be formed with or without heat treatment.

FIG. 2 is a UVPS coating 2 dispersed into a cross-linking resin that is formed on a substrate 1 and applied by the use of a solvent treatment. The coating 2 may be formed with or without heat treatment.

FIG. 3 is a UVPS coating 2 dispersed into a non cross-linking resin that is formed on a substrate 1 and applied with a solvent treatment. The coating 2 may be formed with or without heat treatment.

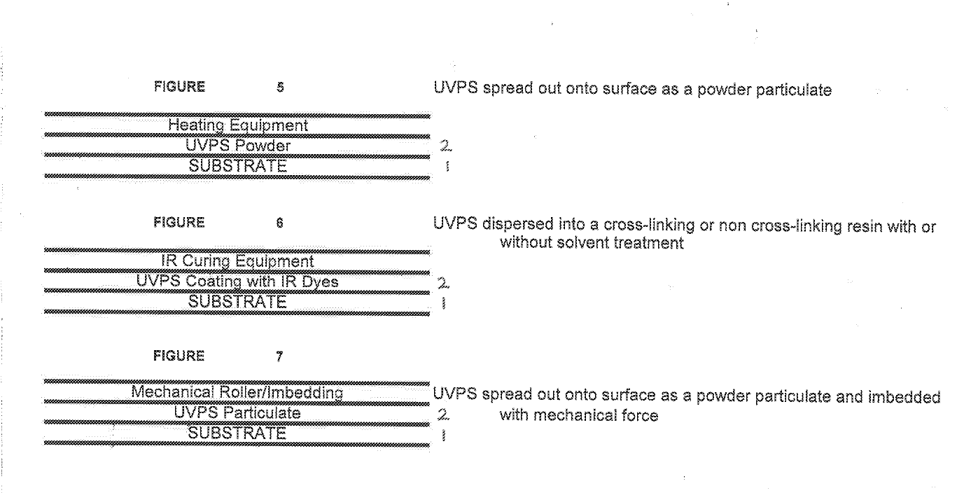

FIG. 4 is a UVPS coating 2 dispersed into a non cross-linking resin that is formed on a substrate 1 and applied with solvent treatment. The coating 2 may be formed with or without heat treatment.

FIG. 5 is a UVPS coating 2 spread out onto a surface as a powder particulate. Heat is used to adhere the powder particles to the substrate 1.

FIG. 6 is a UVPS dispersed into a cross-linking or non cross-linking resin with or without solvent treatment. The coating may contain IR dyes. The coating 2 may be formed with or without heat treatment or cured by IR curing.

FIG. 7 is a UVPS particulate coating 2 spread out onto a substrate 1 as a powder particulate and imbedded with mechanical force.

The ability to deposit any of the structures in a factory environment to generate rolls of finished goods that would be then shipped to jobsites and applied by contractors is desirable. This is particularly important when polyureas are used as layer materials. The process includes casting polyurea resin layers onto a release sheet or structural receiver from a typical slot die coating head and then oven curing the web in line. At a rewind station the polyurea will be stripped, if a release sheet is used, and rolled up on a spool to yield wide webs of roofing material for use. In addition, the reactive chemistry that will be deposited will require precise processing controls and in-line mixing capabilities that restrict the variety of commercially available machines that will be capable of producing this material. These roll goods are converted (slit and/or chopped for example) into tiles, shingles, sheets, etc. for use in the field. These polyurea roll goods may also, as another embodiment, be coated with a PSA (Pressure Sensitive Adhesive) to allow a “peel and stick” approach to site installation.

While polyurea resin is described in the embodiments above, this application may utilize any appropriate resin system depending on the exposure associated to the given application.

The UV Protective System coating may be clear or opaque. The coating may use nano-scale particles of titanium dioxide, iron oxide or other UV blocking inorganic material. Alternatively, these nano-scale particles may be used in combination with well-established organic UV blockers such as Tinuvins™ (Ciba) to yield very strong UV protection while allowing full transmittance of the visible/IR wavelengths that lead to heating, if desired or a combination of UV and IR blocking to reduce heating if that is desired. The importance of nano-scale particles is that when particle size is controlled to be below a given wavelength of light, the particle can no longer absorb or block that wavelength. In some embodiments, it is desirable to block all light exhibiting a wavelength below about 400 nm (block UV). As such, in certain embodiments of the present disclosure, the UV-blocking material comprises particles having a diameter of from 0.005 μm to 0.4 μm. in other embodiments, the particles have a diameter of from 0.01 μm to 2.5 μm.

In other embodiments, it is desired to block a specific wavelength or range of wavelengths of light, while allowing other wavelengths to pass through. For example, in certain substrates, a specific wavelength or range is particularly destructive to the structural integrity of the substrate, whereas other wavelengths may cause no damage to the substrate.

Alternatively, in other embodiments, it may be desired to allow only one wavelength or range of wavelengths through, and block all others. In this case, the UV-blocking material can be processed to allow the tailored wavelength range to pass through.

The concentration of the UV-blocking particles should be sufficient to provided adequate long term protection of the substrate. Generally, the more UV-absorbing particles present in the coating, the greater the protection. However, too high of concentration of the UV-absorbing particles would cause problems in solubility of the particles, and added cost of components. In some embodiments, the concentration of particles in the resin layer is from 0.1 wt % to 50 wt % of the total weight of the layer. In other embodiments, the concentration of particles in the resin layer is from 0.1 wt % to 15 wt % of the total weight of the layer. In yet other embodiments, the concentration is from 0.5% to 1.0% of the total weight of the layer.

UV-blocking particles are comprised of titanium oxide or iron oxide or other oxide material such as tungsten oxide or tungstate, graphene oxide, cerium oxide, nanoceria aluminum oxide, zinc oxide, aluminum hydroxide, and mixtures thereof.

However, any UV-blocking material suitable for use with the materials disclosed herein is acceptable. A method employed to create tunable UV filters according to one embodiment is as follows: Select an aliphatic resin to act as the carrier resin and structural media for the UV filter. The structural media may also be an appropriate receiving media with little to no UV resistance.

Identify the specific UV wavelength range that you wish to allow through the structural media filter and produce a UV protection system particle grind so that the physical size of the particles will mechanically block all UV wavelengths except for the range which you wish to allow to pass through the filter.

Disperse the appropriate size UV protection system into the aliphatic resin.

Spray, cast, extrude, pour, or roll out the resin-particle dispersion onto a release substrate to which the resin will not bond.

Allow resin to set or cure and cut to size for use. The filter will now filter out all UV wavelength ranges and only your selected range will pass through the filter.

### EXAMPLES

Hereinafter, the exemplary embodiment will be described in detail using examples, but is not limited to these examples.

### Example I

1. Substrate

EPDM

2. Nature of the Specific Substrate—

Because EPDM is by nature aromatic, a functionality that is compatible with EPDM is selected, but not chemically identical to the EPDM matrix.

3. Method of Gaining Adhesion or Bonding of UV Protection System to the Substrate—

Determine the best option and compatibility into the chosen resin system: Find a solvent or treatment that will disrupt the crosslinking of the EPDM. It is known that amyl chloride, aromatic hydrocarbons, methylene chloride, lacquer thinners, mineral spirits, and perchloroethylene all attack and can, at sufficient concentration and exposure time, dissolve EPDM.

Also consider the following variables in the selection: cost, availability, flammability, and OSHA Restrictions.

4. Environment where the Application will be Made—

The substrate to be installed is in an outdoor location. Therefore, all environmental, health and safety, and OSHA requirements for this location must be considered and met

5. Identify a Compatible Resin—

The chosen resin system is an aliphatic polyurea. To drive out the perchloroethylene from the coating film, acetone or an environmentally preferable solvent, with properties similar to acetone, known as Ekasol™, available from TBF Environmental Inc. is used. Formulating is performed meeting or exceeding appropriate EPA, VOC, and OSHA requirements, and then formulating is designed such that the solvent blend etches the EPDM, but does not destroy it.

6. Ensure the Resin is Appropriate to the Operating Environment.

### Example II

1. Substrate—

Polyurethane Coating

2. Nature of the Specific Substrate—

Because Polyurethane Coating is by nature hydroxyl functional, a polyurethane resin is used for the UV protection system, so that a chemical bond may be achieved.

3. Method of Gaining Adhesion or Bonding of the UV Protection System to the Substrate—

Determine the best option and compatibility into the chosen resin system: Find a solvent or treatment that will disrupt the crosslinking of the polyurethane coating. Solvents such as acetone, MEK, MIBK may be appropriate, which chemically etch polyurethane.

Also consider the following variables in the selection: cost, availability, flammability, and OSHA Restrictions, along with the degree by which the solvent will cleanly volatilize to ensure intercoat adhesion.

4. Environment where the Application will be Made—

The substrate to be installed is in an outdoor location. Therefore, all environmental, health and safety, and OSHA requirements for this location must he considered and met.

5. Identify a Compatible Resin—

An aliphatic polyurethane is used. Use acetone as a solvent or an environmentally preferable solvent, with properties similar to acetone or MEK. Formulation is performed meeting or exceeding appropriate EPA, VOC, and OSHA requirements, and then formulation is performed such that the solvent blend etches the polyurethane coating, but does not destroy it.

6. Ensure the Resin is Appropriate to the Operating Environment.

### Example III

1. Substrate—

Vinyl Siding

2. Nature of the Specific Substrate—

Due to the environment in which the vinyl siding will need to be restored with the UV protection system, an acrylic resin is selected so that commercially available equipment can be used. Secondly, acrylic resin is selected for ease of use, with the most likely installer base, and for its ability to be modified for adhesion into plastic polymers.

3. Method of Gaining Adhesion or Bonding of the UV Protection System to the Substrate—

Vinyl siding is made with PVC and known to be chemically resistant. Therefore an abrasion pretreatment may be required, followed by an organic solvent or oxidizing agent. Solvents such as isopropyl acetate, n-Butyl acetate, MEK, MIBK, methylene chloride, perchlorethylene, propionic acid, and pyridine may be appropriate solvents.

4. Environment where the Application will be Made—

The substrate to be installed is in an outdoor location. Therefore, all environmental, health and safety, and OSHA requirements for this location must be considered and met.

5. Identify a Compatible Resin—

In this case, use an acrylic resin with aliphatic properties, with adhesion promotion for poly vinyl chloride.

6. Ensure the Resin is Appropriate to the Operating Environment.

### Example IV

A test was performed to demonstrate and quantify the performance of certain materials in allowing UV light waves to pass through these materials. These materials are “filter films” prepared using DYNA-PUR 9166 Clear Brushable Aliphatic Polyaspartic Polyurea (9166), available through Creative Material Technologies, Ltd. of Palmer, Mass., USA. In addition, separate filter films are prepared using additives incorporated into the 9166 to test the UV filtering capabilities of the additives. The additives utilized are nanoparticles designed to block the UV light waves.

Filter films were prepared using 1) zero pigment added, 2) DYNA-PUR 9166 clear, adding no commercially available UV stabilization additives (e.g.: Tinuvin), 3) aluminum oxide (Nabaltec, Schwandorf, Germany) at 2% by weight, and 4) graphene oxide (GO) at a 2% by weight concentration. Each filter film was created by drawing down the liquid 9166 at an average film thickness of 17 mils. These filter films were created on a release paper, so that they can be completely removed for testing purposes.

To determine the UV filtering capabilities, “exposure films” are prepared using a UV sensitive material. The material used is DYNA-PUR 1137 Unpigmented Aromatic Pure Polyurea (1137). Each exposure film is prepared by drawing down the liquid 1137 at an average film thickness of 8 mils, applied on white card stock that is an average thickness of 8 mils.

“Gradient evaluation films” are created by exposing UV-A light (Dymax 5000-EC Lamp unit, Dymax Metal Halide 400 watt UV bulb, Torrington, Conn.) to an exposure film in incremental time allotments of 0.5 minutes to 10 minutes. The gradient evaluation film is used as an optical comparison in gauging the changes to the exposure films after UV light exposure.

Best practices are used to maintain consistent conditions. The films are kept at a consistent distance from the UV light. An “Exposure Template Assembly” is made to hold the exposure films and the filter films to avoid any inconsistencies in placement or caused by any warping or bending of the films.

Results

Results are taken from three filter films that have been exposed to UV light. These results are shown below in Table 1 and have been averaged for the following determinations.

| | | | 9166 with | 9166 with |
|---|---|---|---|---|
| | No | 9166 | Aluminum | graphene |
| | Filter | alone | Oxide | oxide |
| Protection | 0 | 60 | 75 | 95 |
| amount | | | | |
| (%) | | | | |

The same three filter films were evaluated for degradation performance when exposed to UV light. These results are shown in Table 2 and have been averaged for the following determinations.

UV Test Results - Percentage Degradation

Filter

| | | | 9166 with | 9166 with |
|---|---|---|---|---|
| | No | 9166 | Aluminum | graphene |
| | Filter | alone | Oxide | oxide |
| Test 1 | 100 | 15.0 | 10.0 | <1 |
| Test 2 | 100 | 20.0 | 15.0 | <1 |
| Test 3 | 100 | 20.0 | 15.0 | <1 |
| Average | 100 | 18.3 | 13.3 | <1 |

Additional work would be required by any given user to optimize a selective UV blocking system once the user determined what selective wavelength range was desirable to block. This example demonstrates the art while not limiting it to any given selective wavelength range.

The present disclosure can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the disclosure. However, it should be recognized that the present disclosure can he practiced without resorting to the details specifically set forth. In other instances, well known processing structures have not been described in detail, in order not to unnecessarily obscure the present disclosure.

What is claimed is:

1. A method for protecting a substrate from degradation comprising:
treating a surface of the substrate to allow a UV blocking agent to adhere to the surface of the substrate,
applying the UV blocking agent to the surface of the substrate, and
allowing the surface of the substrate to harden, thereby adhering the UV blocking agent to the surface of the substrate.

2. The method of claim 1, wherein treating the surface of the substrate includes exposing the surface of the substrate to a solvent capable of softening the surface of the substrate to a sufficient degree to allow for the UV blocking agent to adhere to the surface.

3. The method of claim 1, wherein treating the surface of the substrate includes heating the surface of the substrate to soften the surface of the substrate to a sufficient degree to allow for the UV blocking agent to adhere to the surface in such a degree as to limit the exposure of UV radiation to the surface.

4. The method of claim 1, wherein treating the surface of the substrate includes applying a sufficient amount of an adhesive to the surface of the substrate to allow for the UV blocking agent to adhere to the surface in such a degree as to limit the exposure of UV radiation to the surface.

5. The method of claim 1, wherein applying the UV blocking agent to the surface of the substrate includes mixing the UV blocking agent with a resin to form a resin and UV blocking agent mixture and applying the mixture to the surface of the substrate.

6. The method of claim 1, wherein the UV blocking agent is at least one selected from the group consisting of titanium oxide, iron oxide, tungsten oxide, tungstate, graphene oxide, cerium oxide, nanoceria, aluminum oxide, zinc oxide, and aluminum hydroxide.

7. The method of claim 6, wherein the UV blocking agent comprises graphene oxide and aluminum oxide.

8. The method of claim 5, wherein the concentration of UV blocking agent in the UV blocking agent and resin mixture is from 0.1 wt % to 50 wt % of the total weight of the mixture.

9. The method of claim 5, wherein the concentration of UV blocking agent in the UV blocking agent and resin mixture is from 0.1 wt % to 10 wt % of the total weight of the mixture.

10. The method of claim 5, wherein the mixture is applied to the substrate by spraying, casting, extruding, or pouring the mixture onto the substrate.

11. The method of claim 1, wherein the UV blocking agent has a particle size capable of allowing a predetermined UV wavelength to pass through without being blocked.

12. The method of claim 1, wherein the substrate is EPDM, polyurethane, TPO, acrylate, or vinyl.

13. The method of claim 3, wherein the solvent is at least one selected from the group consisting of amyl chloride, aromatic hydrocarbons, ketones, methylene chloride, lacquer thinners, mineral spirits, perchlorethylene, acetone, methylethyl ketone, methyl isobutyl ketone, isopropyl acetate, propionic acid, pyridine, and n-Butyl acetate.

14. The method of claim 1, wherein the UV blocking agent is capable of blocking at least 90% of UV radiation from being exposed to the substrate.

15. A UV protection system, comprising:
a substrate having a surface; and
a UV blocking agent at the surface of the substrate,
wherein the UV protection system is formed by:
treating a surface of the substrate to allow a UV blocking agent to adhere to the surface of the substrate,
applying the UV blocking agent to the surface of the substrate, and
allowing the surface of the substrate to harden, thereby adhering the UV blocking agent to the surface of the substrate.

16. A roofing material comprising the UV protection system of claim 15.

17. An object that is exposed to sunlight, the object comprising the UV protection system of claim 15.

18. A stand-alone UV filter laminate, coating, or object whereby the filter formed by the method of claim 1 is physically placed between or above the source of the UV and an object or surface to be protected.

19. A method of laminating a pre-formed coating comprising the UV protection system of claim 15 onto another receiving surface.

20. A method of blocking selected ranges of UV radiation and allowing other wavelengths to pass through using the UV protecting system of claim 15.
